(19) United States
(12) Patent Application Publication
(10) Pub. No.: US 2026/0328899 A1
(43) Pub. Date: Oct. 22, 2026

(54) PULSE RADAR DEVICE AND OPERATING METHOD OF PULSE RADAR DEVICE

(71) Applicant: ELECTRONICS AND TELECOMMUNICATIONS RESEARCH INSTITUTE, Daejeon (KR)

(72) Inventor: Pil Jae PARK, Daejeon (KR)

(21) Appl. No.: 19/372,785

(22) Filed: Oct. 29, 2025

(30) Foreign Application Priority Data
Apr. 16, 2025 (KR) 10-2025-0049286

(51) Int. Cl. G01S 7/292; G01S 7/28; G01S 7/282; G01S 13/10

(52) U.S. Cl. CPC G01S 7/2921; G01S 7/2806; G01S 7/282; G01S 13/106

(57) ABSTRACT

Disclosed is a pulse radar device including a clock generation unit that outputs a transmission clock signal and outputs a reception clock signal that is delayed from the transmission clock signal by a transmission/reception (TRX) clock delay value, a transmitting unit that radiates a transmission pulse toward a target by accepting the transmission clock signal, a receiving unit that receives an echo pulse from the target by accepting the reception clock signal and outputs digital signals based on the echo pulse, and a signal processing unit that generates scan vectors each corresponding to a scan cycle based on the digital signals and generates representative scan vectors each corresponding to a representative scan cycle based on the scan vectors. The signal processing unit adjusts a data collection cycle to control an operation mode of the pulse radar device.

### CROSS-REFERENCE TO RELATED APPLICATION

This application claims priority under 35 U.S.C. § 119 to Korean Patent Application No. 10-2025-0049286 filed on Apr. 16, 2025, in the Korean Intellectual Property Office, the disclosures of which are incorporated by reference herein in their entireties.

### BACKGROUND

### 1. Field of the Invention

The present disclosure relates to a pulse radar device, and more particularly to a pulse radar device for operating at low power by adjusting a data collection cycle and operating method of the pulse radar device.

### 2. Description of Related Art

A pulse radar device that uses a pulse as a transmission signal repeatedly transmits a transmission pulse. A receiving unit of the pulse radar device receives an echo pulse in which the transmission pulse hits a target and returns. The pulse radar device acquires information about the target based on the received echo pulse.

The pulse radar device operates based on a clock signal.

A transmitting unit of the pulse radar device radiates a transmission pulse through a transmitting antenna using a transmission clock signal. The receiving unit of the pulse radar device receives the echo pulse using a reception clock signal.

### SUMMARY

Embodiments of the present disclosure provide a pulse radar device for detecting a target with low power and operating method of the pulse radar device

According to an embodiment of the present disclosure, a pulse radar device includes a clock generation unit, a transmitting unit, a receiving unit, and a signal processing unit. The clock generation unit outputs a transmission clock signal and outputs a reception clock signal after a time delay. The time delay value is referred to as a transmission/reception (TRX) clock delay value. The transmitting unit radiates a transmission pulse toward a target by accepting the transmission clock signal. The receiving unit receives an echo pulse from the target by accepting the reception clock signal, and outputs digital signals based on the echo pulse. The signal processing unit generates a plurality of scan vectors each corresponding to a scan cycle based on the digital signals, and generates representative scan vectors each corresponding to a representative scan cycle based on the plurality of the scan vectors. The signal processing unit adjusts a data collection cycle to control an operation mode of the pulse radar device.

According to an embodiment of the present disclosure, the operation mode is one of a first mode of performing a detection operation and a second mode of not performing the detection operation.

According to an embodiment of the present disclosure, the scan vectors include a first scan vector generated during a first scan period corresponding to the scan cycle. During the first scan period, the TRX clock delay value is sequentially varied from a minimum TRX clock delay value to a maximum TRX clock delay value. During the first scan period, the signal processing unit generates, based on the digital signals, representative digital signal values corresponding to each of the minimum TRX clock delay value to the maximum TRX clock delay value, and generates the first scan vector based on the representative digital signal values.

According to an embodiment of the present disclosure, during a first representative scan period, the signal processing unit generates a first representative scan vector corresponding to the representative scan cycle. The first representative scan vector is generated based on the first scan vector generated during the first scan period and the second scan vector generated during a second scan period. The signal processing unit generates a first scan matrix based on the first scan vector and the second scan vector. And the signal processing unit generates a first representative scan vector based on the first scan matrix.

According to an embodiment of the present disclosure, the data collection cycle corresponds to a time interval in which the first scan vector and the second scan vector are collected. The pulse radar device operates in the first mode during the first scan period and the second scan period.

According to an embodiment of the present disclosure, the pulse radar device operates in the second mode during a low power period between the first scan period and the second scan period.

According to an embodiment of the present disclosure, the representative scan vectors include a second representative scan vector generated during a second representative scan period corresponding to the representative scan cycle. The data collection cycle corresponds to a time interval in which the first representative scan vector and the second representative scan vector are collected. The pulse radar device operates in a first mode during the first representative scan period and the second representative scan period.

According to an embodiment of the present disclosure, the pulse radar device operates in the second mode during the low power period between the first representative scan period and the second representative scan period.

According to an embodiment of the present disclosure, the signal processing unit generates representative digital signal values by performing an operation on the plurality of digital signals collected in a section in which the TRX clock delay value is the same during the first scan period. The operation is an addition operation, an average operation, or the like.

According to an embodiment of the present disclosure, the first scan matrix has a size of m × n. The first scan matrix includes first to m-th row vectors. The first to m-th row vectors corresponds to first to m-th scan vectors, respectively. Each of the first to m-th scan vectors includes n representative digital signal values as elements. The first scan matrix includes first to n-th column vectors. Each of the first to n-th column vectors includes m elements.

According to an embodiment of the present disclosure, the signal processing unit performs an operation of converting the first scan matrix into the first representative scan vector. As a result of the operation, the first scan matrix having a size of m × n is transformed into a first representative scan vector having a size of 1 × n. The operation is one of a first operation, a second operation, a third operation, and a fourth operation. The first operation is an operation of converting each of the column vectors of the first scan matrix into the first representative scan vector by summing elements of each of the column vectors. The second operation is an operation of converting each of the column vectors of the first scan matrix into the first representative scan vector by averaging the elements of each of the column vectors. The third operation is an operation of converting each of the column vectors of the first scan matrix into the first representative scan vector by averaging elements of each of the column vectors with different weights. The fourth operation is an operation of converting each of the column vectors of the first scan matrix into the first representative scan vector by subtracting the m-th element from the average value of the first to (m−1)th elements of each of the column vectors.

According to an embodiment of the present disclosure, the signal processing unit outputs a minimum distance notification signal synchronized with the scan cycle, and outputs a representative scan vector notification signal synchronized with the representative scan cycle.

According to an embodiment of the present disclosure, the signal processing unit acquires a target response associated with bio-signal of the target based on the scan vectors or the representative scan vectors during response acquisition time. The signal processing unit analyzes the characteristics of the bio-signal based on the Fourier transform for the target response. The response acquisition time associated with a reciprocal of a minimum frequency of the bio-signal. The data collection cycle is associated with a reciprocal of a maximum frequency of the bio-signal.

According to an embodiment of the present disclosure, the clock generation unit includes a delay locked loop circuit that fixes the TRX clock delay value. The delay locked loop circuit includes a multi-stage voltage controlled delay element that generates a plurality of clock signals by accepting a reference clock signal and a multiplex switch that selects the transmission clock signal and the reception clock signal from among the plurality of clock signals.

According to an embodiment of the present disclosure, the transmitting unit includes a variable duration generator that generates a variable oscillation duration from an edge of the transmission clock signal by accepting the transmission clock signal, a voltage controlled oscillator that generates the transmission pulse during a time corresponding to the variable oscillation duration, and a transmitting antenna that radiates the transmission pulse to the target. At least one of the variable range generator and the voltage controlled oscillator is deactivated during the second mode.

According to an embodiment of the present disclosure, the receiving unit includes a receiving antenna that receives an echo pulse, a low noise amplifier that amplifies the received echo pulse, a wideband sampler that samples the amplified signal from the low noise amplifier, a baseband amplifier that amplifies the sampled signal from the wideband sampler, and an analog-to-digital converter that converts the amplified signal from the baseband amplifier into the digital signals. During the second mode, at least one of the low noise amplifier, the wideband sampler, the baseband amplifier and the analog-to-digital converter is deactivated.

According to an embodiment of the present disclosure, a pulse radar device includes a clock generation unit, a multi-transmitting unit, multi-receiving unit, and a signal processing unit. The clock generation unit outputs transmission clock signals, and outputs reception clock signals by delaying each of the transmission clock signals by a transmission/reception (TRX) clock delay value. The multi-transmitting unit includes a plurality of transmitters, each configured to radiate a transmission pulse toward a target by accepting one of the transmission clock signals. The multi-receiving unit includes a plurality of receivers, each configured to receive an echo pulse from the target by accepting one of the reception clock signals and to output digital signals based on the echo pulse. The signal processing unit generates scan vectors each corresponding to a scan cycle based on digital signals, and generates representative scan vectors each corresponding to a representative scan cycle based on the scan vectors. The signal processing unit adjusts a data collection cycle to control an operation mode of the pulse radar device. The operation mode is one of a first mode of performing a detection operation and a second mode of not performing the detection operation.

According to an embodiment of the present disclosure, the data collection cycle corresponds to a time interval in which a first scan vector and a second scan vector of the scan vectors are collected. The first scan vector is generated during a first scan period corresponding to the scan cycle. The second scan vector is generated during a second scan period corresponding to the scan cycle. The first scan period and the second scan period are discontinuous.

According to an embodiment of the present disclosure, the pulse radar device operates in the first mode during the first scan period and the second scan period. The pulse radar device operates in the second mode during a third scan period between the first scan period and the second scan period.

According to an embodiment of the present disclosure, the data collection cycle corresponds to a time interval in which a first representative scan vector and a second representative scan vector of the representative scan vectors are collected. The first representative scan vector is generated during a first representative scan period corresponding to the representative scan cycle. The second representative scan vector is generated during a second representative scan period corresponding the representative scan cycle. The first representative scan period and the second representative scan period are discontinuous.

According to an embodiment of the present disclosure, the pulse radar device operates in the first mode during the first representative scan period and the second representative scan period. The pulse radar device operates in the second mode during a third representative scan period between the first representative scan period and the second representative scan period.

### BRIEF DESCRIPTION OF THE DRAWINGS

The above and other objects and features of the present disclosure will become apparent by describing in detail embodiments thereof with reference to the accompanying drawings.

FIG. 1 illustrates a pulse radar device according to an embodiment of the present disclosure.

FIG. 2 illustrates an example of a scan vector generated by a pulse radar device according to an embodiment of the present disclosure.

FIG. 3 illustrates an example of a scan matrix generated by signal processing of a pulse radar device according to an embodiment of the present disclosure.

FIG. 4 illustrates an example of a representative scan vector generated by signal processing of a pulse radar device according to an embodiment of the present disclosure.

FIG. 5 illustrates an example of a representative scan cycle according to an embodiment of the present disclosure.

FIG. 6 illustrates an example of low power operation of a pulse radar device according to an embodiment of the present disclosure.

FIG. 7 illustrates another example of low power operation of a pulse radar device according to an embodiment of the present disclosure.

FIG. 8 illustrates an example of acquiring a target response associated with a bio-signal of a target according to an embodiment of the present disclosure.

FIG. 9 illustrates another example of acquiring a target response associated with a bio-signal of a target according to an embodiment of the present disclosure.

FIG. 10 illustrates an example of a clock generation unit of a pulse radar device according to an embodiment of the present disclosure.

FIG. 11 illustrates an example of a transmitter included in a transmitting unit of a pulse radar device according to an embodiment of the present disclosure.

FIG. 12 illustrates an example of a receiver included in a receiving unit of a pulse radar device according to an embodiment of the present disclosure.

FIG. 13 illustrates a pulse radar device according to an embodiment of the present disclosure.

### DETAILED DESCRIPTION

Hereinafter, embodiments of the present disclosure may be described in detail and clearly to such an extent that an ordinary one in the art easily implements the present disclosure.

Components that are described in the detailed description with reference to the terms “unit”, “module”, “block”, “~er or ~or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

In the present disclosure, each of the phrases such as “A or B,” “at least one of A and B,” “at least one of A or B,” “A, B, or C,” “at least one of A, B, and C,” and “at least one of A, B, or C” is intended to encompass any one of the listed elements and all possible combinations thereof.

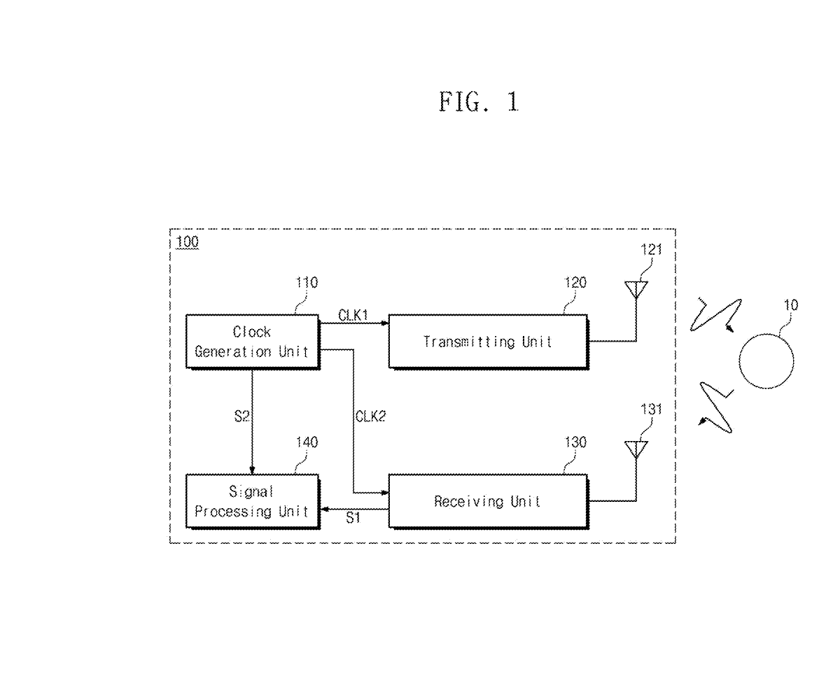

FIG. 1 illustrates a pulse radar device according to an embodiment of the present disclosure. Referring to FIG. 1, pulse radar device 100 may include a clock generation unit 110, a transmitting unit 120, a receiving unit 130, and a signal processing unit 140.

The clock generation unit 110 may generate a transmission clock signal CLK1 used to generate a transmission signal (e.g., a transmission pulse) at the transmitting unit 120. The clock generation unit 110 may generate a reception clock signal CLK2used to receive a signal (e.g., an echo pulse) at the receiving unit 130. The clock generation unit 110 may output the transmission clock signal CLK1 to the transmitting unit 120 and output the reception clock signal CLK2 to the receiving unit 130.

The clock generator 110 may output a second signal S2. For example, the clock generation unit 110 may output a synchronization signal having cycle information of a delay (hereinafter, referred to as a “transmission/reception (TRX) clock delay value”) between the transmission clock signal CLK1 and the reception clock signal CLK2 to the signal processing unit 140.

Each of the transmission clock signal CLK1 and the reception clock signal CLK2 may periodically have a logic low value or a logic high value. A logic high value and a logic low value of the transmission clock signal CLK1 and the reception clock signal CLK2 may respectively correspond to a magnitude of a specific voltage.

The clock generation unit 110 may output the reception clock signal CLK2 to the receiving unit 130 after a TRX clock delay value has passed from a point in time when the transmission clock signal CLK1 is output to the transmitting unit 120. The TRX clock delay value may correspond to a detection distance of the pulse radar device 100. The clock generation unit 110 may adjust the detection distance of the pulse radar device 100 by adjusting the TRX clock delay value. For example, as the TRX clock delay value increases, the detection distance of the pulse radar device 100 may become longer. As the TRX clock delay value decreases, the detection distance of the pulse radar device 100 may be shorter.

The transmitting unit 120 may accept the transmission clock signal CLK1 from the clock generation unit 110. The transmitting unit 120 may radiate the transmission pulse to the target 10 based on the transmission clock signal CLK1. For example, the transmission 120 may use the transmission clock signal CLK1 as a transmission trigger signal to radiate the transmission pulse to the target 10 through a transmitting antenna 121.

The receiving unit 130 may accept the reception clock signal CLK2 from the clock generation unit 110. The receiving unit 130 may receive a signal reflected from the target 10 based on the reception clock signal CLK2. For example, the receiving unit 130 may receive the echo pulse through a receiving antenna 131 based on the reception clock signal CLK2. The echo pulse is associated with the transmission pulse and may include information about the target 10 (e.g., a position of the target, a velocity of the target, a bio-signal of the target, etc.). The receiving unit 130 may process the echo pulse to output a reception signal S1.

In an embodiment, the reception signal S1 may be digital signals. For example, the reception signal S1 may be digital signals based on the echo pulse.

The signal processing unit 140 may acquire information on the target 10 based on the reception signal S1 output from the receiving unit 130. For example, the signal processing unit 140 may process the reception signal S1 to generate data (for example, a scan vector, a scan matrix, or a representative scan vector). The signal processing unit 140 may acquire the information about the target 10 based on the generated data. The signal processing unit 140 may store the generated data or the acquired information.

In an embodiment, the signal processing unit 140 may process the data based on the synchronization signal received from the clock generation unit 110.

In an embodiment, the signal processing unit 140 may output a data notification signal indicating that data has been collected (e.g., generated or stored). For example, the signal processing unit 140 may output a scan vector notification signal indicating that the scan vector has been collected and a representative scan vector notification signal indicating that the representative scan vector has been collected.

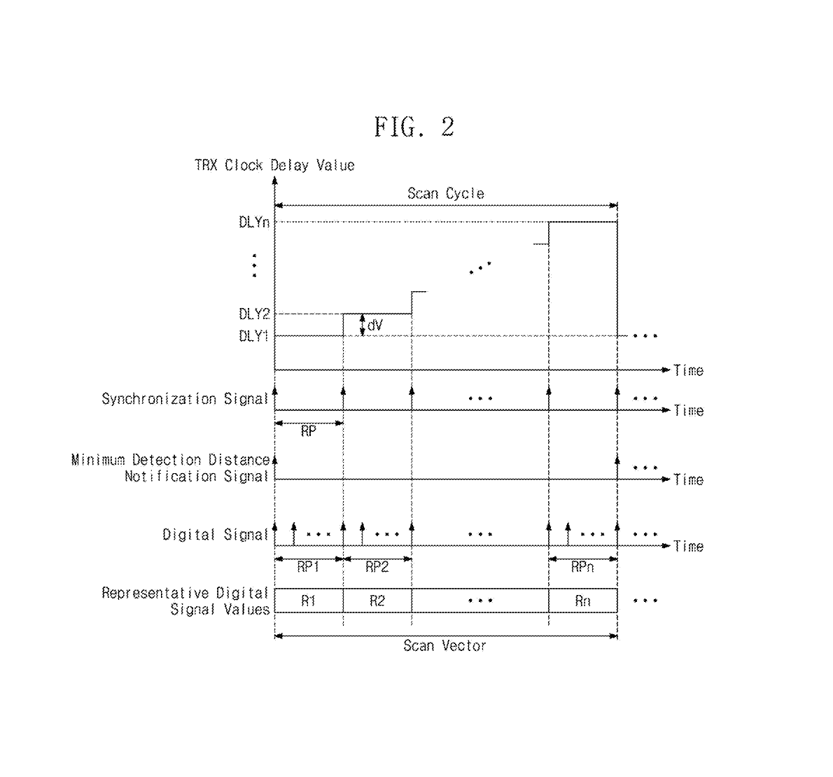

FIG. 2 illustrates an example of a scan vector generated by a pulse radar device according to an embodiment of the present disclosure. Referring to FIGS. 1 and 2, a pulse radar device 100 may detect a detection distance corresponding to a TRX clock delay value. The pulse radar device 100 may repeatedly detect a distance by periodically varying a TRX clock delay value.

A clock generation unit 110 may adjust the TRX clock delay value. The TRX clock delay value may be varied from a first TRX clock delay value DLY1 to the n-th TRX clock delay value DLYn. For example, the TRX clock delay value may be increased by a constant change value dV from the first TRX clock delay value DLY1 to the n-th TRX clock delay value DLYn. When the TRX clock delay value is changed, the clock generation unit 110 may output a synchronization signal to the signal processing unit 140.

In an embodiment, the first TRX clock delay value DLY1 may indicate a minimum TRX clock delay value corresponding to a minimum detection distance of the pulse radar device 100, and the n-th TRX clock delay value DLYn may indicate a maximum TRX clock delay value corresponding to a maximum detection distance of the pulse radar device 100.

During a delay value retention period RP, the TRX clock delay value may be maintained at the same value. For example, the TRX clock delay value may be maintained at each of the first TRX clock delay value DLY1 through the n-th TRX clock delay value DLYn during the delay value retention period RP.

The TRX clock delay value may be periodically increased from the first TRX clock delay value DLY1 to the n-th TRX clock delay value DLYn. For example, the TRX clock delay value may be increased from the first TRX clock delay value DLY1 to the n-th TRX clock delay value DLYn during a period corresponding to scan cycle. During the next period corresponding to the scan cycle, the TRX clock delay value may be increased again from the first TRX clock delay value DLY1 to the n-th TRX clock delay value DLYn.

The clock generation unit 110 may output a minimum detection distance notification signal when the TRX clock delay value is the first TRX clock delay value DLY1. For example, the clock generation unit 110 may output the minimum detection distance notification signal at a point in time when the initial first TRX operation starts. In addition, the clock generation unit 110 may output the minimum detection distance notification signal at a point in time when the TRX clock delay value changes from the n-th TRX clock delay value DLYn to the first TRX clock delay value DLY1.

In an embodiment, the minimum detection distance notification signal may be a signal synchronized with the scan cycle.

A receiving unit 130 may convert an echo pulse corresponding to the same TRX clock delay value into digital signals. The receiving unit 130 may transmit the converted digital signals to a signal processor 140.

The signal processing unit 140 may generate a scan vector corresponding to the scan cycle based on the digital signals. For example, the signal processing unit 140 may perform an operation on the digital signals corresponding to a first delay value retention period RP1 to generate a first representative digital signal value R1. The signal processing unit 140 may perform the operation on the digital signals corresponding to a second delay value retention period RP2 to generate a second representative digital signal value R2. Similarly, the signal processing unit 140 may perform the operation on the digital signals corresponding to the n-th delay value retention period RPn to generate the n-th representative digital signal value Rn. The first representative digital signal value R1 to the n-th representative digital signal value Rn may constitute elements of a scan vector. That is, a first to n-th elements of the scan vector may correspond to the first representative digital signal value R1 to the n-th representative digital signal value Rn, respectively, and the scan vector may be a row vector having a size of 1 × n.

In an embodiment, during the delay value retention period RP, the operation on the digital signals for generating the representative digital signal value may be one of an addition operation and an average operation.

In an embodiment, during the delay value retention period RP, the signal processing unit 140 may generate two or more representative digital signal values by performing the operation on digital signals.

For example, the signal processing unit 140 may generate two or more representative digital signal values by performing the operation on the digital signals corresponding to the first delay value retention period RP1. The signal processing unit 140 may generate two or more representative digital signal values by performing the operation on the digital signals corresponding to the second delay value retention period RP2. Similarly, the signal processing unit 140 may generate two or more representative digital signal values by performing the operation on the digital signals corresponding to the n-th delay value retention period RPn.

In an embodiment, the signal processing unit 140 may output a scan vector notification signal indicating that the scan vector has been collected.

As described above, the pulse radar device 100 may repeatedly detect a distance from a minimum detection distance to a maximum detection distance by repeatedly performing the TRX operation during a period corresponding to the scan cycle.

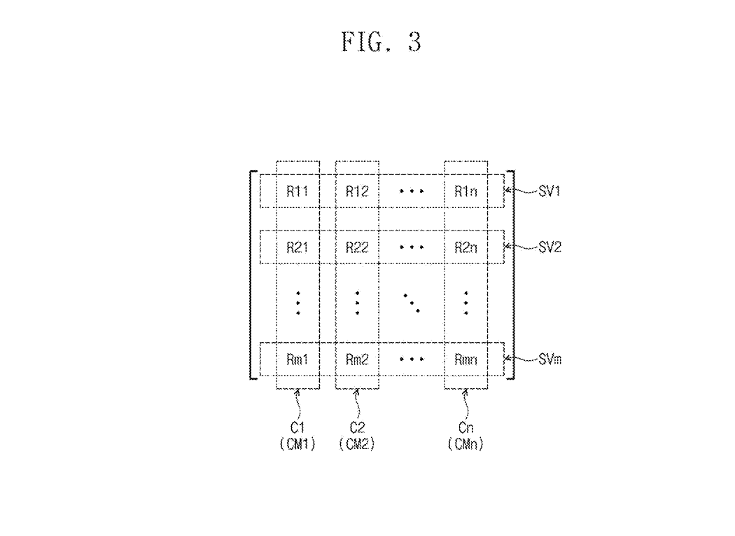

FIG. 3 illustrates an example of a scan matrix generated by signal processing of a pulse radar device according to an embodiment of the present disclosure. Referring to FIGS. 1-3, a pulse radar device 100 may generate a scan matrix based on a plurality of scan vectors SV1 to SVm.

Each of the plurality of scan vectors SV1 to SVm may be generated during a scan cycle. For example, the first scan vector SV1 may be generated during a first scan period corresponding to a scan cycle. The second scan vector SV2 may be generated during a second scan period corresponding to the scan cycle. Similarly, the m-th scan vector SVm may be generated during an m-th scan period corresponding to a scan cycle.

The plurality of scan vectors SV1 to SVm may respectively correspond to rows of the scan matrix. For example, the first scan vector SV1 may correspond to a first row of the scan matrix. The second scan vector SV2 may correspond to a second row of the scan matrix. Similarly, the m-th scan vector SVm may correspond to the m-th row of the scan matrix. That is, the number of rows of the scan matrix may correspond to the number of the plurality of scan vectors SV1 to SVm (or the number of scan periods). In an embodiment, each of the plurality of scan vectors SV1 to SVm may be a row vector having a size of 1 × n. That is, the scan matrix may include first through m-th row vectors.

Each of the rows included in the scan matrix may include first to n-th elements. The first to n-th elements of each row of the scan matrix may correspond to first to n-th representative digital signal values of each scan vector SV.

For example, the first to n-th elements of the first row of the scan matrix may correspond to first to n-th representative digital signal values R11 to R1n included in the first scan vector SV1. The first to n-th elements of the second row of the scan matrix may correspond to first to n-th representative digital signal values R21 to R2n included in the second scan vector SV2. Similarly, the first to n-th elements of the m-th row of the scan matrix may correspond to the first to n-th representative digital signal values Rm1 to Rmn included in the m-th scan vector SVm.

The scan matrix may include a plurality of column vectors CM1 to CMn. Each of the plurality of column vectors CM1 to CMn may have a size of m × 1. The column vector CM1 may correspond to a first column C1 among first to n-th columns C1 to Cn of the scan matrix. The second column vector CM2 may correspond to the second column C2 among the first to n-th columns C1-Cn of the scan matrix. Similarly, the n-th column vector CMn may correspond to the n-th column Cn among the first to n-th columns C1 to Cn of the scan matrix.

The number of columns of the scan matrix may correspond to the number of representative digital signal values (or the number of minimum to maximum TRX clock delay values) included in each scan vector.

Each of the plurality of column vectors CM1 to CMn may include first to m-th elements. The first to m-th elements of the first column vector CM1 may respectively correspond to the first representative digital signal values R11 to Rm1 of the plurality of scan vectors SV1 to SVm. The first to m-th elements of the second column vector CM2 may respectively correspond to the second representative digital signal values R12 to Rm2 of the plurality of scan vectors SV1 to SVm. Similarly, the first to m-th elements of the n-th column vector CMn may respectively correspond to the n-th representative digital signal values R1n to Rmn of the plurality of scan vectors SV1 to SVm.

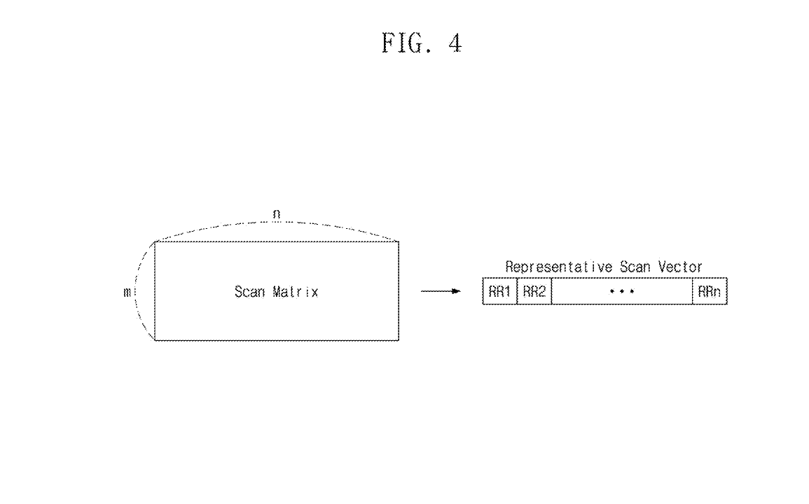

FIG. 4 illustrates an example of a representative scan vector generated by signal processing of a pulse radar device according to an embodiment of the present disclosure. Referring to FIGS. 1-4, a signal processing unit 140 of a pulse radar device 100 may generate a representative scan vector based on a scan matrix. The representative scan vector may be a row vector having a size of 1 × n. The representative scan vector may include first to n-th elements.

The signal processing unit 140 may generate the first to n-th elements of the representative scan vector based on column vectors CM1 to CMn of the scan matrix. For example, the signal processing unit 140 may generate a first representative value RR1 based on an operation on the first to m-th elements of the first column vector CM1 of the scan matrix. The signal processing unit 140 may generate a second representative value RR2 based on the operation on the first to m-th elements of the second column vector CM2 of the scan matrix. Similarly, the signal processing unit 140 may generate an n-th representative value RRn based on the operation on the first to m-th elements of the n-th column vector CMn of the scan matrix. The first representative value RR1 to the n-th representative value RRn may constitute the elements of the representative scan vector. That is, the first to n-th elements of the representative scan vector may correspond to the first to n-th representative values RR1 to RRn, respectively.

In an embodiment, the operation on the first to m-th elements of each column vector of the scan matrix may be one of first to fourth operations. The first operation may be an addition operation. The second operation may be an average operation. The third operation may be an average operation based on different weights. The fourth operation may be an operation based on the average operation and a subtraction operation. For example, the fourth operation on the first to m-th elements may be the subtraction operation between a result of the average operation on the first to (m−1)-th elements and the m-th element.

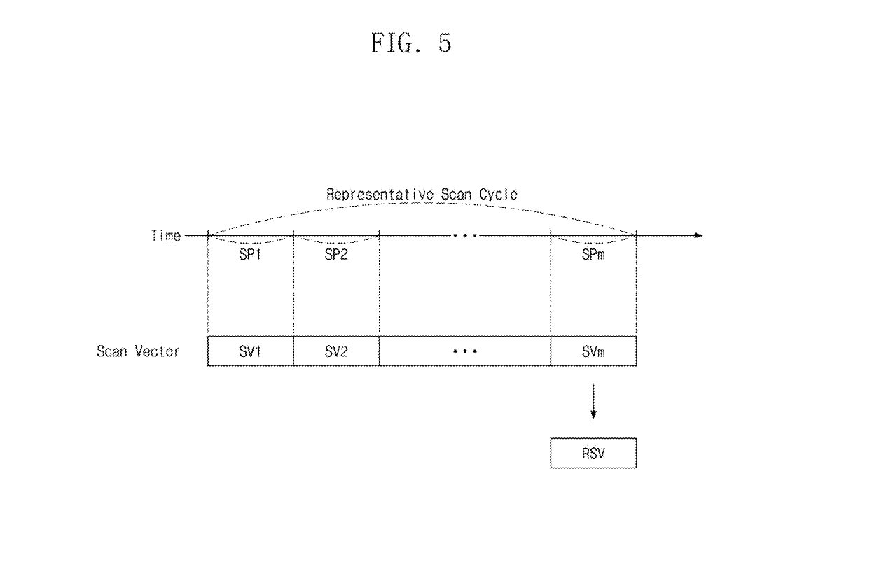

FIG. 5 illustrates an example of a representative scan cycle according to an embodiment of the present disclosure. Referring to FIGS. 1-5, a representative scan cycle may indicate a cycle for generating a representative scan vector RSV. The representative scan cycle may include first to m-th scan periods SP1 to SPm. Each of the first to m-th scan periods SP1 to SPm may correspond to a scan cycle.

The first to m-th scan periods SP1 to SPm may be continuous with each other. For example, a pulse radar device 100 may generate a first scan vector SV1 during the first scan period SP1. Thereafter, the pulse radar device 100 may generate a second scan vector SV2 during the second scan period SP2 that it continuous with the first scan period SP1. Similarly, the pulse radar device 100 may generate the m-th scan vector SVm during the m-th scan period SPm that is continuous with the (m-1)-th scan period SP(m-1).

The pulse radar device 100 may generate a scan matrix based on the first to m-th scan vectors SV1 to SVm, and generate the representative scan vector RSV based on the scan matrix.

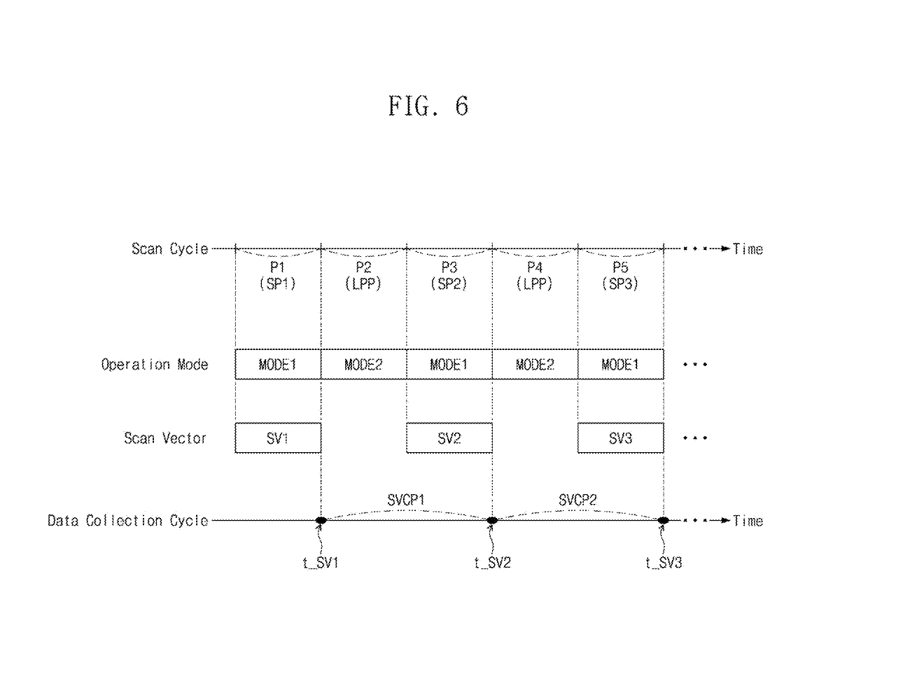

FIG. 6 illustrates an example of low power operation of a pulse radar device according to an embodiment of the present disclosure.

In FIG. 6, first to fifth periods P1 to P5 are assumed to be continuous with each other.

Referring to FIGS. 1 and 6, a pulse radar device 100 may control an operation mode by adjusting a data collection cycle. The data collection cycle may correspond to a cycle of collecting a scan vector (hereinafter referred to as a ‘scan vector collection cycle’). In an embodiment, the data collection cycle may indicate a data generation cycle or a data storage cycle.

During the first period P1, a pulse radar device 100 may operate in a first mode MODE1. The first period P1 may indicate a first scan period SP1 for performing a detection operation (or a TRX operation) for collecting a first scan vector SV1. The first mode MODE1 may indicate a mode for performing the detection operation. As a result of operating in the first mode MODE1, the pulse radar device 100 may collect the first scan vector SV1. A first time point t_SV1 may indicate a time point at which the collection of the first scan vector SV1 is completed.

During the second period P2, the pulse radar device 100 may operate in a second mode MODE2. The second period P2 may indicate a low power period LPP during which the detection operation is not performed. For example, the second mode MODE2 may indicate a mode in which some components of the pulse radar device 100 are deactivated or operate at low power.

During the third period P3, the pulse radar device 100 may operate in the first mode MODE1. The third period P3 may indicate a second scan period SP2 for performing the detection operation for collecting a second scan vector SV2. As a result of operating in the first mode MODE1, the pulse radar device 100 may collect the second scan vector SV2. A second time point t_SV2 may indicate a time point at which the collection of the second scan vector SV2 is completed.

A time interval between the first time point t_SV1 and the second time point t_SV2 may indicate a first scan vector collection period SVCP1 corresponding to the scan vector collection cycle. The first scan vector collection period SVCP1 may correspond to a sum of the second period P2 and the third period P3.

During the fourth period P4, the pulse radar device 100 may operate in the second mode MODE2. The fourth period P4 may indicate the low power period LPP during which the detection operation is not performed.

During the fifth period P5, the pulse radar device 100 may operate in the first mode MODE1. The fifth period P5 may indicate a third scan period SP3 for performing the detection operation for collecting a third scan vector SV3. As a result of operating in the first mode MODE1, the pulse radar device 100 may collect the third scan vector SV3. A third time point t_SV3 may indicate a time point at which the collection of the third scan vector SV3 is completed.

A time interval between the second time point t_SV2 and the third time point t_SV3 may indicate a second scan vector collection period SVCP2 corresponding to the scan vector collection cycle. The second scan vector collection period SVCP2 may correspond to a sum of the fourth period P4 and the fifth period P5.

In an embodiment, the first period P1, the third period P3, and the fifth period P5 may correspond to a scan cycle. In an embodiment, each of the second period P2 and the fourth period P4 corresponding to the low power period LPP may be an arbitrary period. For example, the second period P2 and the fourth period P4 may be set based on a frequency of bio-signal of a target 10.

In an embodiment, a signal processing unit 140 may output a data notification signal indicating that data has been collected. For example, the signal processing unit 140 may output a scan vector notification signal at each of the first to third time points t_SV1, t_SV2, and t_SV3. The scan vector notification signal may be signal synchronized with the scan cycle.

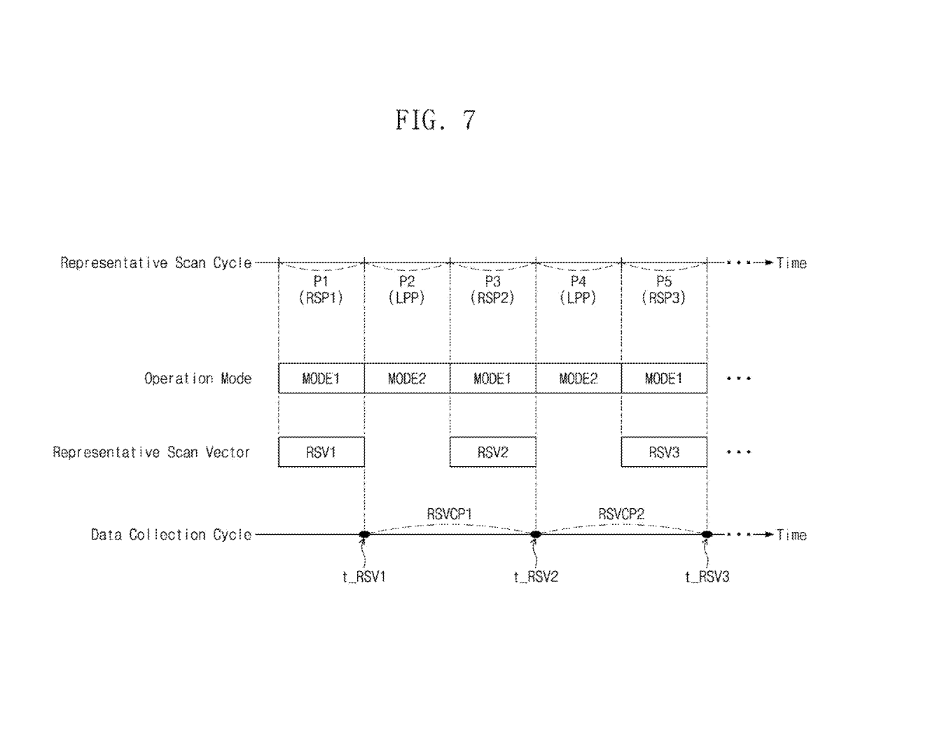

FIG. 7 illustrates another example of low power operation of a pulse radar device according to an embodiment of the present disclosure.

In FIG. 7, first to fifth periods P1 to P5 are assumed to be continuous with each other.

Referring to FIGS. 1 and 7, the pulse radar device 100 may control an operation mode by adjusting a data collection cycle. The data collection cycle may correspond to a cycle of collecting a representative scan vector (hereinafter referred to as a “representative scan vector collection cycle”). In an embodiment, the data collection cycle may indicate a data generation cycle or a data storage cycle.

During the first period P1, a pulse radar device 100 may operate in a first mode MODE1. The first period P1 may indicate a first representative scan period RSP1 for performing a detection operation for collecting a first representative scan vector RSV1. As a result of operating in the first mode MODE1, the pulse radar device 100 may collect the first representative scan vector RSV1. A first time point t_RSV1 may indicate a time point at which the collection of the first representative scan vector RSV1 is completed.

During the second period P2, the pulse radar device 100 may operate in the second mode MODE2. The second period P2 may represent a low-power period LPP during which the detection operation is not performed.

During the third period P3, the pulse radar device 100 may operate in the first mode MODE1. The third period P3 may indicate a second representative scan period RSP2 for performing the detection operation for collecting a second representative scan vector RSV2. As a result of operating in the first mode MODE1, the pulse radar device 100 may collect the second representative scan vector RSV2. A second time point t_RSV2 may indicate a time point at which the collection of the second representative scan vector RSV2 is completed.

A time interval between the first time point t_RSV1 and the second time point t_ RSV2 may indicate a first representative scan vector collection period RSVCP1 corresponding to the representative scan vector collection cycle. The first representative scan vector collection period RSVCP1 may correspond to a sum of the second period P2 and the third period P3.

During the fourth period P4, the pulse radar device 100 may operate in the second mode MODE2. The fourth period P4 may represent the low power period LPP during which the detection operation is not performed.

During the fifth period P5, the pulse radar device 100 may operate in the first mode MODE1. The fifth period P5 may indicate a third representative scan period RSP3 for performing the detection operation for collecting a third representative scan vector RSV3. As a result of operating in the first mode MODE1, the pulse radar device 100 may collect the third representative scan vector RSV3. A third time point t_SV3 may indicate a time point at which the collection of the third representative scan vector RSV3 is completed.

A time interval between the second time point t_RSV2 and the third time point t_ RSV3 may indicate a second representative scan vector collection period RSVCP2 corresponding to the representative scan vector collection cycle. The second representative scan vector collection period RSVCP2 may correspond to a sum of the fourth period P4 and the fifth period P5.

In an embodiment, the first period P1, the third period P3, and the fifth period P5 may correspond to a representative scan cycle. In an embodiment, each of the second period P2 and the fourth period P4 corresponding to the low power period LPP may be an arbitrary period. For example, the second period P2 and the fourth period P4 may be set based on a frequency of a bio-signal of a target 10.

In an embodiment, a signal processing unit 140 may output a data notification signal indicating that data has been collected. For example, the signal processing unit 140 may output a representative scan vector notification signal at each of the first to third time points t_RSV1, t_RSV2, and t_RSV3. The representative scan vector notification signal may be a signal synchronized with the representative scan cycle.

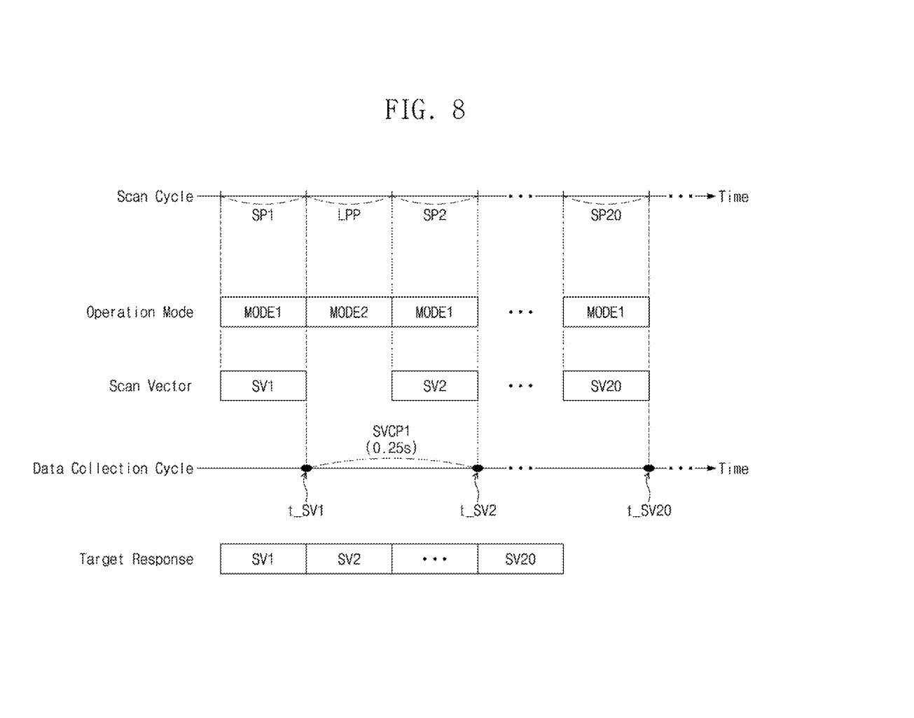

FIG. 8 illustrates an example of acquiring a target response associated with a bio-signal of a target according to an embodiment of the present disclosure.

In FIG. 8, it is assumed that a bio-signal of a target 10 has a minimum frequency of 0.2 Hz and a maximum frequency of 2 Hz. In FIG. 8, the data collection cycle is assumed to correspond to a scan vector collection cycle. Further, in FIG. 8, each of the first to twentieth scan periods SP1 to SP20 is assumed to correspond to a scan cycle.

Referring to FIGS. 1, 6, and 8, a pulse radar device 100 acquires a target response associated with the bio-signal of the target 10 during a time for acquiring the target response (hereinafter referred to as a “response acquisition time”). For example, the pulse radar device 100 may collect a plurality of scan vectors SV1 to SV20 during the response acquisition time. Each of the plurality of scan vectors SV1 to SV20 may include bio-signal information of the target 10. The pulse radar device 100 may acquire the target response based on the plurality of scan vectors SV1 to SV20. In an embodiment, the bio-signal of the target 10 may indicate a periodic signal, such as respiration. In an embodiment, the target response may be acquired when a characteristic of a frequency or a frequency range of the bio-signal of the target 10 is determined.

The response acquisition time may be determined based on the minimum frequency of the bio-signal. For example, the response acquisition time may be associated with a reciprocal of the minimum frequency of the bio-signal. Since the minimum frequency is 0.2 Hz, the response acquisition time may be 5 seconds (or 5 seconds or more). That is, the pulse radar device 100 may acquire a characteristic of the bio-signal of the target 10 based on the plurality of scan vectors SV1 to SV20.

The data collection cycle of the pulse radar device 100 for acquiring the target response may be determined based on the maximum frequency of the bio- signal. For example, the data collection cycle of the pulse radar device 100 may be associated a reciprocal of the maximum frequency of the bio-signal. Since the maximum frequency is 2 Hz, the data collection cycle of the pulse radar device 100 may be a reciprocal of 4 Hz (or 4 Hz or more), which is twice the maximum frequency according to a nyquist sampling theorem. That is, the data collection cycle may be 0.25 seconds (or 0.25 seconds or less).

The pulse radar device 100 may collect the plurality of scan vectors SV1 to SV20 by alternately operating in a first mode and a second mode during the response acquisition time.

For example, during a first scan period SP1, the pulse radar device 100 may operate in the first mode MODE1. As a result of operating in the first mode MODE1, the pulse radar device 100 may collect the first scan vector SV1. A first time point t_SV1 may indicate a time point at which the collection of the first scan vector SV1 is completed. After the first scan period SP1, the pulse radar device 100 may operate in the second mode MODE2 during a low power period LPP.

During a second scan period SP2, the pulse radar device 100 may operate in the first mode MODE1. As a result of operating in the first mode MODE1, the pulse radar device 100 may collect the second scan vector SV2. A second time point t_SV2 may indicate a time point at which the collection of the second scan vector SV2 is completed. After the second scan period SP2, the pulse radar device 100 may operate in the second mode MODE2 during the low power period LPP.

Similarly, during a twentieth scan period SP20, the pulse radar device 100 may operate in the first mode MODE1. As a result of operating in the first mode MODE1, the pulse radar device 100 may collect the 20th scan vector SV20. A 20th time point t_SV20 may indicate a time point at which the collection of the 20th scan vector SV20 is completed.

The pulse radar device 100 may acquire the target response based on the plurality of scan vectors SV1 to SV2. For example, the plurality of scan vectors SV1 to SV20 may respectively correspond to first to twentieth elements of the target response.

In an embodiment, the pulse radar device 100 may specify the first to twentieth elements of the target response based on the plurality of scan vectors SV1 to SV20. For example, the pulse radar device 100 may specify the first element of the target response from the first scan vector SV1 based on a constant false alarm rate (CFAR) detection method. The pulse radar device 100 may specify the second element of the target response from the second scan vector SV2 based on the CFAR detection method. Similarly, the pulse radar device 100 may specify the twentieth element of the target response from the 20th scan vector SV20 based on the CFAR detection method.

The pulse radar device 100 may analyze characteristics of the bio-signal based on the target response. For example, the pulse radar device 100 may analyze the characteristics of the bio-signal based on the target response using a fast Fourier transform (FFT) method.

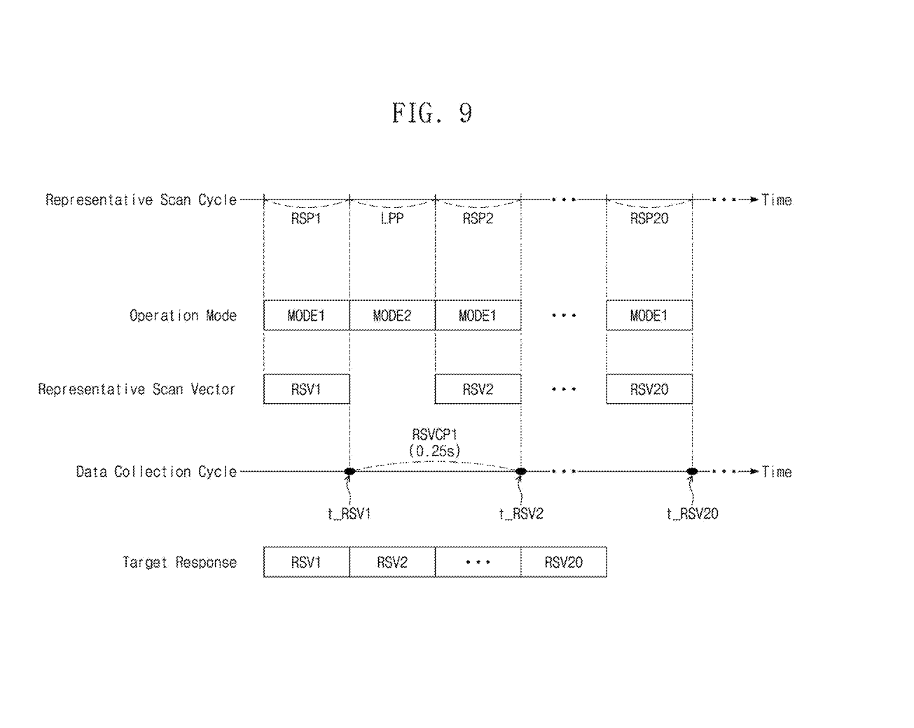

FIG. 9 illustrates another example of acquiring a target response associated with a bio-signal of a target according to an embodiment of the present disclosure.

In FIG. 9, it is assumed that a bio-signal of a target 10 has a minimum frequency of 0.2 Hz and a maximum frequency of 2 Hz. In FIG. 9, the data collection cycle is assumed to correspond to a representative scan vector collection cycle. Further, in FIG. 9, each of first to twentieth representative scan periods RSP1 to RSP20 is assumed to correspond to a representative scan cycle.

Referring to FIGS. 1, 7, and 9, a pulse radar device 100 may acquire a target response associated with the bio-signal of the target 10 during a response acquisition time. For example, the pulse radar device 100 may collect a plurality of representative scan vectors RSV1 to RSV20 during the response acquisition time. Each of the plurality of representative scan vectors RSV1 to RSV20 may include bio-signal information of the target 10. The pulse radar device 100 may acquire the target response based on the plurality of representative scan vectors RSV1 to RSV20. In an embodiment, the target response may be acquired when a characteristic of a frequency or a frequency range of the bio-signal of the target 10 is determined.

The response acquisition time may be determined based on the minimum frequency of the bio-signal. For example, the response acquisition time may be associated with a reciprocal of the minimum frequency. Since the minimum frequency is 0.2 Hz, the response acquisition time may be 5 seconds (or 5 seconds or more). That is, the pulse radar device 100 may acquire a characteristic of the bio-signal of the target 10 based on the plurality of representative scan vectors RSV1 to RSV20.

The data collection cycle of the pulse radar device 100 for acquiring the target response may be determined based on the maximum frequency of the bio-signal. For example, the data collection cycle of the pulse radar device 100 may be associated with a reciprocal of the maximum frequency. Since the maximum frequency is 2 Hz, the data collection cycle of the pulse radar device 100 may be a reciprocal of 4 Hz (or 4 Hz or more), which is twice the maximum frequency according to a nyquist sampling theorem. That is, the data collection cycle may be 0.25 seconds (or 0.25 seconds or less).

The pulse radar device 100 may collect the plurality of representative scan vectors RSV1 to RSV20 by alternately operating in a first mode and a second mode during the response acquisition time.

For example, during a first representative scan period RSP1, the pulse radar device 100 may operate in the first mode MODE1. As a result of operating in the first mode MODE1, the pulse radar device 100 may collect the first representative scan vector RSV1. A first time point t_RSV1 may indicate a time point at which the collection of the first representative scan vector RSV1 is completed. After the first representative scan period RSP1, the pulse radar device 100 may operate in the second mode MODE2 during a low power period LPP.

During a second representative scan period RSP2, the pulse radar device 100 may operate in the first mode MODE1. As a result of operating in the first mode MODE1, the pulse radar device 100 may collect the second representative scan vector RSV2. A second time point t_RSV2 may indicate a time point at which the collection of the second representative scan vector RSV2 is completed. After the second representative scan period RSP2, the pulse radar device 100 may operate in the second mode MODE2 during the low power period LPP.

Similarly, during a twentieth representative scan period RSP20, the pulse radar device 100 may operate in the first mode MODE1. As a result of operating in the first mode MODE1, the pulse radar device 100 may collect the twentieth representative scan vector RSV20. A twentieth time point t_RSV20 may indicate a time point at which the collection of the twentieth representative scan vector SRV2 is completed.

The pulse radar device 100 may acquire the target response based on the plurality of representative scan vectors RSV1 to RSV20. For example, the plurality of representative scan vectors RSV1 to RSV20 may respectively correspond to first to twentieth elements of the target response.

In an embodiment, the pulse radar device 100 may specify the first to twentieth elements of the target response based on the plurality of representative scan vectors RSV1 to RSV20. For example, the pulse radar device 100 may specify the first element of the target response from the first representative scan vector RSV1 based on a CFAR detection method. The pulse radar device 100 may specify the second element of the target response from the second representative scan vector RSV2 based on the CFAR detection method. Similarly, the pulse radar device 100 may specify the twentieth element of the target response from the twentieth representative scan vector RSV20 based on the CFAR detection method.

The pulse radar device 100 may analyze characteristics of the bio-signal based on the target response. For example, the pulse radar device 100 may analyze the characteristics of the bio-signal based on the target response using a fast Fourier transform (FFT) method.

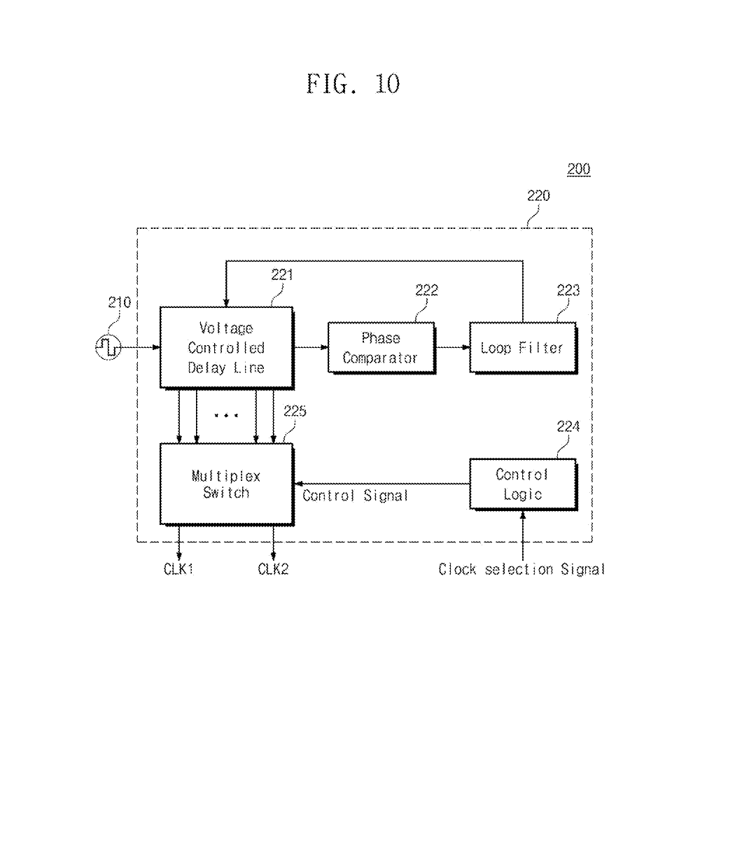

FIG. 10 illustrates an example of a clock generation unit of a pulse radar device according to an embodiment of the present disclosure. Referring to FIG. 10, a clock generator 200 may include a reference clock generator 210 and a delay locked loop (DLL) 220.

The reference clock generator 210 may generate a reference clock signal. The reference clock generator 210 may transmit the reference clock signal to the DLL 220.

The DLL 220 may include a voltage controlled delay line (VCDL) 221, a phase comparator 222, a loop filter 223, control logic 224, and a multiplex switch 225. The DLL 220 may generate a TRX clock delay value based on the reference clock signal.

The VCDL 221 may include a plurality of voltage controlled delay elements. The plurality of voltage controlled delay elements may constitute a multi-stage voltage controlled delay element.

The VCDL 221 may accept the reference clock signal from the reference clock generator 210 and a direct current (DC) voltage from the loop filter 223. The VCDL 221 may operate based on the DC voltage accepted from the loop filter 223. An output of the VCDL 221 may be an output of each stage of the multi-stage voltage controlled delay element driven by the reference clock signal. The output of each stage of the multi-stage voltage control delay element may be a clock signal having different clock delay values.

The phase comparator 222 may output a pulse voltage proportional to a phase difference between signals input to the phase comparator 212.

The loop filter 223 may include a capacitor. The loop filter 223 may convert the pulse voltage output from the phase comparator 222 into the DC voltage. For example, the loop filter 223 may remove the high frequency component of the pulse voltage output from the phase comparator 222 to convert the pulse voltage to the DC voltage. The loop filter 223 may apply the converted DC voltage to the VCDL 221.

The control logic 224 may control operations of the DLL 220. For example, the control logic 224 may output a control signal to control the multiplex switch 225.

The multiplex switch 225 may select a transmission clock signal CLK1 and a reception clock signal CLK2 among clock signals received from the VCDL 221. For example, the multiplex switch 225 may operate based on the control signal received from the control logic 224. The multiplex switch 225 may select the transmission clock signal CLK1 and the reception clock signal CLK2 among the clock signals having different clock delay values of the VCDL 221.

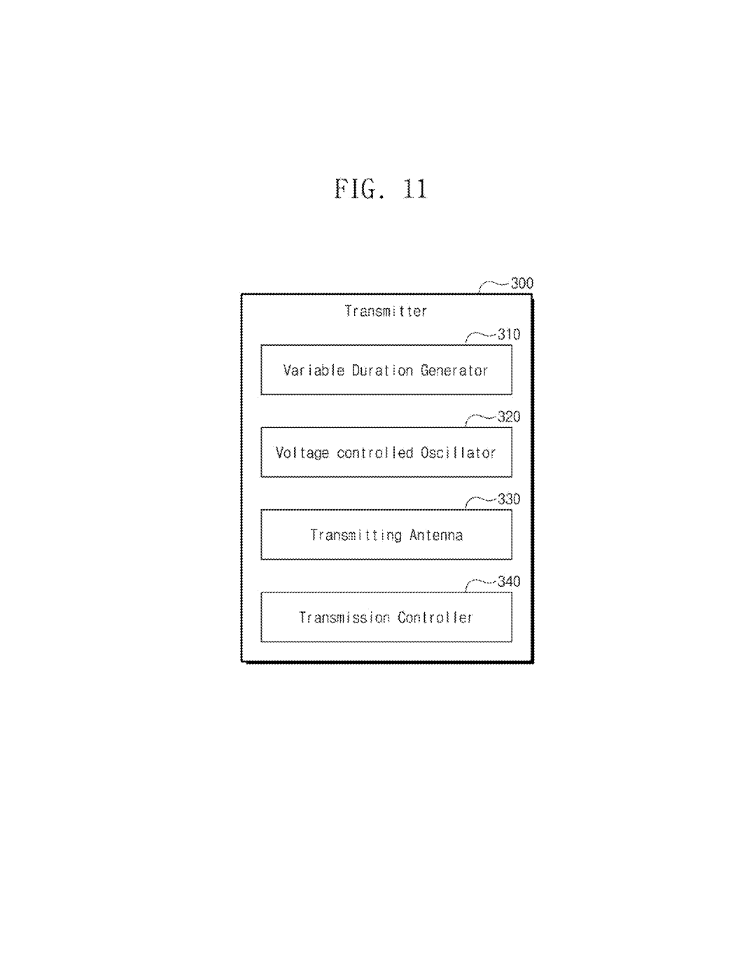

FIG. 11 illustrates an example of a transmitter included in a transmitting unit of a pulse radar device according to an embodiment of the present disclosure.

Referring to FIG. 11, a transmitter 300 may include a variable duration generator 310, a voltage controlled oscillator 320, a transmitting antenna 330, and a transmission controller 340.

The variable duration generator 310 may accept a transmission clock signal to generate a variable oscillation duration, which is defined an edge of the transmission clock signal.

The voltage controlled oscillator 320 may generate a transmission pulse that oscillates for a time corresponding to the variable oscillation duration. A center frequency of the voltage controlled oscillator 320 may be varied.

The transmitting antenna 330 may radiate the transmission pulse to a target.

The transmission controller 340 may control an operation of the transmitter 300. For example, the transmission controller 340 may output control signals for controlling operations of the variable duration generator 310, the voltage controlled oscillator 320, and the transmitting antenna 330.

In an embodiment, when the transmitter 300 operates in a second mode, at least one of the variable duration generator 310, the voltage controlled oscillator 320, and the transmit antenna 330 may be deactivated under the control of the transmission controller 340.

In an embodiment, the transmitter 300 may be implemented as an integrated circuit.

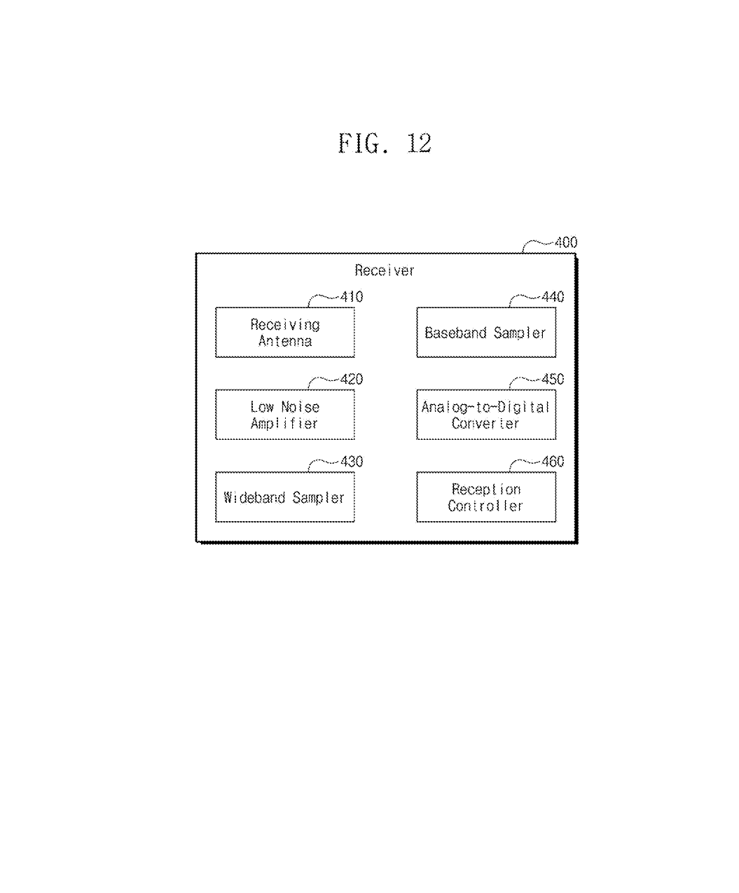

FIG. 12 illustrates an example of a receiver included in a receiving unit of a pulse radar device according to an embodiment of the present disclosure.

Referring to FIG. 12, a receiver 400 may include a receiving antenna 410, a low noise amplifier 420, a wideband sampler 430, a baseband amplifier 440, an analog-to-digital converter 450, and a reception controller 460.

The receiving antenna 410 may receive an echo pulse reflected by a target.

The low noise amplifier 420 may be connected with the receiving antenna 410. The low noise amplifier 420 may amplify the echo pulse with low noise. The low noise amplifier 420 may amplify the echo pulse such that noise of the echo pulse is minimized.

The wideband sampler 430 may be connected with the low noise amplifier 420. The wideband sampler 430 may accept a reception clock signal from the clock generation unit 110 of FIG. 1 to sample the output of the low noise amplifier 420.

The baseband amplifier 440 may amplify the signal sampled from the wideband sampler 430.

The analog-to-digital converter 450 may convert the signal output from the baseband amplifier 440 into digital signals.

The reception controller 460 may control an operation of the receiver 400. For example, the reception controller 460 may output control signals for controlling operations of the receiving antenna 410, the low noise amplifier 420, the wideband sampler 430, the baseband amplifier 440, and the analog-to-digital converter 450.

In an embodiment, when the receiver 400 operates in a second mode, at least one of the receiving antenna 410, the low noise amplifier 420, the wideband sampler 430, the baseband amplifier 440, and the analog-to-digital converter 450 may be deactivated under the control of the reception controller 460.

In an embodiment, the receiver 400 may be implemented as an integrated circuit.

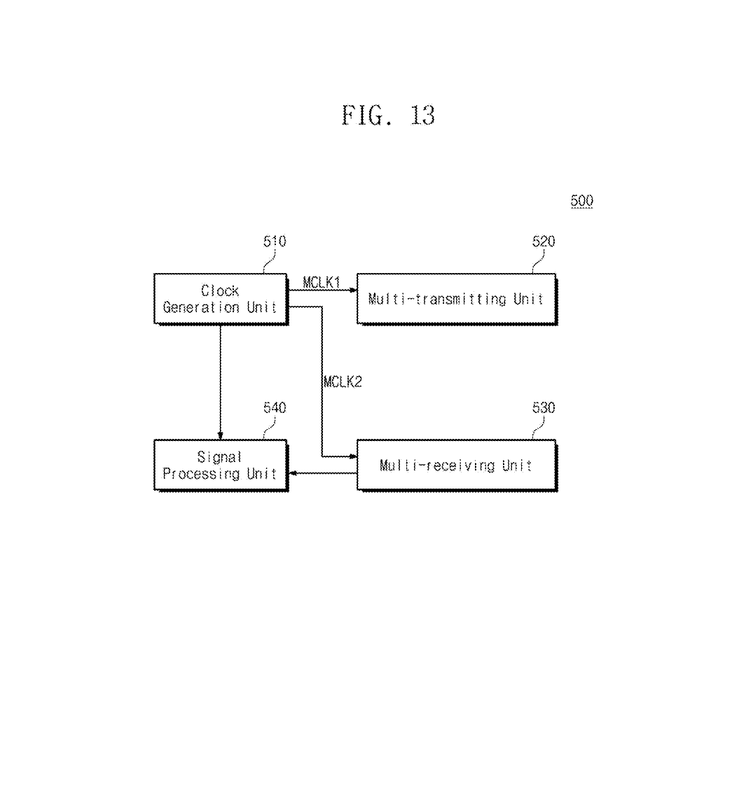

FIG. 13 shows a pulse radar device according to an embodiment of the present disclosure.

Referring to FIG. 13, a pulse radar device 500 may include a clock generation unit 510, a multi-transmitting unit 520, a multi-receiving unit 530, and a signal processing unit 540.

In FIG. 13, the signal processing unit 540 may perform the same or similar operation as the signal processing unit 140 of FIG. 1. Therefore, redundant descriptions are omitted for convenience of description.

The clock generation unit 510 may generate multi-transmission clock signals MCLK1 used to generate transmission signals at the multi-transmitting unit 520. The clock generator 510 may generate multi-reception clock signals MCLK2 used to receive an echo pulse at the multi-receiving unit 530. The clock generation unit 510 may output the multi-transmission clock signals MCLK1 to the multi-transmitting unit 520 and output the multi-reception clock signals MCLK2 to the multi-receiving unit 530. In an embodiment, the multi-transmission clock signals MCLK1 may include a plurality of transmission clock signals, and the multi-reception clock signal MCLK2 may include a plurality the reception clock signals.

The multi–transmitting unit 520 may include a plurality of transmitters. Each of the plurality of transmitters may radiate the transmission pulse towards a target based on one of the transmission clock signals.

The multi-receiving unit 530 may include a plurality of receivers. Each of the plurality of receivers may receive the echo pulse from the target based on one of the reception clock signals. The multi–receiving unit 530 may output digital signals based on the echo pulse.

In an embodiment, each of the reception clock signals may have a different clock delay value.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

According to the invention, the pulse radar device may operate at low power when given a characteristic of a target or when sensing a specific frequency range of the target.

According to the invention, a transmitter and a receiver of the pulse radar device may be implemented as an integrated circuit.

What is claimed is:

1. A pulse radar device comprising:
a clock generation unit configured to output a transmission clock signal and to output a reception clock signal that is delayed from the transmission clock signal by a transmission/reception (TRX) clock delay value;
a transmitting unit configured to radiate a transmission pulse toward a target by accepting the transmission clock signal;
a receiving unit configured to receive an echo pulse from the target by accepting the reception clock signal and to output digital signals based on the echo pulse; and
a signal processing unit configured to generate scan vectors each corresponding to a scan cycle based on the digital signals, and to generate representative scan vectors each corresponding to a representative scan cycle based on the scan vectors,
wherein the signal processing unit configured to adjust a data collection cycle to control an operation mode of the pulse radar device.

2. The pulse radar device of claim 1, wherein the operation mode is one of a first mode of performing a detection operation and a second mode of not performing the detection operation.

3. The pulse radar device of claim 2, wherein the scan vectors include a first scan vector generated during a first scan period corresponding to the scan cycle,
wherein, during the first scan period, the TRX clock delay value is sequentially varied from a minimum TRX clock delay value to a maximum TRX clock delay value, and
wherein, during the first scan period, the signal processing unit is configured to:
generate, based on first digital signals corresponding to the first scan period among the digital signals, representative digital signal values corresponding to each of the minimum TRX clock delay value to the maximum transmission/reception clock delay value; and
generate the first scan vector based on the representative digital signal values.

4. The pulse radar device of claim 3, wherein the representative scan vectors include a first representative scan vector generated during a first representative scan period corresponding to the representative scan cycle, and
wherein, during the first representative scan period, the signal processing unit is configured to:
generate the first scan vector during the first scan period;
generate a second scan vector during a second scan period corresponding to the scan cycle;
generate a first scan matrix based on the first scan vector and the second scan vector; and
generate the first representative scan vector based on the first scan matrix.

5. The pulse radar device of claim 4, wherein the data collection cycle corresponds to a time interval in which the first scan vector and the second scan vector are collected, and
wherein the pulse radar device operates in the first mode during the first scan period and the second scan period.

6. The pulse radar device of claim 5, wherein the pulse radar device operates in the second mode during a low power period between the first scan period and the second scan period.

7. The pulse radar device of claim 4, wherein the representative scan vectors include a second representative scan vector generated during a second representative scan period corresponding to the representative scan cycle,
wherein the data collection cycle corresponds to a time interval in which the first representative scan vector and the second representative scan vector are collected, and
wherein the pulse radar device operates in the first mode during the first representative scan period and the second representative scan period.

8. The pulse radar device of claim 7, wherein the pulse radar device operates in the second mode during a low power period between the first representative scan period and the second representative scan period.

9. The pulse radar device of claim 4, wherein the signal processing unit configured to generate the representative digital signal values based on an operation on the first digital signals; and
wherein the operation is one of an addition operation and an average operation.

10. The pulse radar device of claim 4, wherein the first scan matrix includes first to n-th column vectors, where n is a number of the representative digital signal values,
wherein each of the first to n-th column vectors includes first to m-th elements, where m is a number of scan vectors included in the first scan matrix,
wherein the signal processing unit configured to generate the first representative scan vector based on an operation on the first to m-th elements,
wherein the operation is one of a first operation, a second operation, a third operation, and a fourth operation, and
wherein the first operation is an addition operation, the second operation is an average operation, the third operation is an average operation based on different weights, and the fourth operation is subtraction operation between a result of the average operation on the first to (m−1)th elements and the m-th element.

11. The pulse radar device of claim 4, wherein the signal processing unit configured to output a minimum distance notification signal synchronized with the scan cycle, and to output a representative scan vector notification signal synchronized to the representative scan cycle.

12. The pulse radar device of claim 4, wherein the signal processing unit configured to:
during a response acquisition time, acquire a target response associated with a bio-signal of the target based on the scan vectors or the representative scan vectors; and
analyze a characteristic of the bio-signal based on a Fourier transform on the target response,
wherein the response acquisition time is associated with a reciprocal of a minimum frequency of the bio-signal, and
wherein the data collection cycle is associated with a reciprocal of a maximum frequency of the bio-signal.

13. The pulse radar device of claim 4, wherein the clock generation unit includes a delay locked loop circuit configured to generate the TRX clock delay value, and
wherein the delay locked loop circuit includes:
a multi-stage voltage controlled delay element configured to generate a plurality of clock signals by accepting a reference clock signal; and
a multiplex switch configured to select the transmission clock signal and the reception clock signal from among the plurality of clock signals.

14. The pulse radar device of claim 4, wherein the transmitting unit includes:
a variable duration generator configured to generate a variable oscillation duration from an edge of the transmission clock signal by accepting the transmission clock signal;
a voltage controlled oscillator configured to generate the transmission pulse during a time corresponding to the variable oscillation duration; and
a transmitting antenna configured to radiate the transmission pulse to the target, and
wherein, during the second mode, at least one of the variable duration generator and the voltage controlled oscillator is deactivated.

15. The pulse radar device of claim 4, wherein the receiving unit includes:
a receiving antenna configured to receive the echo pulse;
a low noise amplifier configured to amplify the received echo pulse;
a wideband sampler configured to sample the amplified signal from the low noise amplifier;
a baseband amplifier configured to amplify the sampled signal from the wideband sampler; and
an analog-to-digital converter configured to convert the amplified signal from the baseband amplifier into the digital signals,
wherein at least one of the low noise amplifier, the wideband sampler, the baseband amplifier and the analog-to-digital converter is deactivated during the second mode.

16. A pulse radar device comprising:
a clock generation unit configured to output transmission clock signals, and to output reception clock signals by delaying each of the transmission clock signals by a transmission/reception (TRX) clock delay value;
a multi-transmitting unit including a plurality of transmitters, each configured to radiate a transmission pulse toward a target by accepting one of the transmission clock signals;
a multi-receiving unit including a plurality of receivers, each configured to receive an echo pulse from the target by accepting one of the reception clock signals and to output digital signals based on the echo pulse; and
a signal processing unit configured to generate scan vectors each corresponding to a scan cycle based on the digital signals, and to generate representative scan vectors each corresponding to a representative scan cycle based on the scan vectors,
wherein the signal processing unit configured to adjust a data collection cycle to control an operation mode of the pulse radar device, and
wherein the operation mode is one of a first mode of performing a detection operation and a second mode of not performing the detection operation.

17. The pulse radar device of claim 16, wherein the data collection cycle corresponds to a time interval in which a first scan vector and a second scan vector of the scan vectors are collected,
wherein the first scan vector is generated during a first scan period corresponding to the scan cycle, and the second scan vector is generated during a second scan period corresponding to the scan cycle, and
wherein the first scan vector and the second scan vector are discontinuous.

18. The pulse radar device of claim 17, wherein the pulse radar device configured to:
operate in the first mode during the first scan period and the second scan period; and
operate in the second mode during a third scan period between the first scan period and the second scan period.

19. The pulse radar device of claim 16, wherein the data collection cycle corresponds to a time interval in which a first representative scan vector and a second representative scan vector of the representative scan vectors are collected,
wherein the first representative scan vector is generated during a first representative scan period corresponding to the representative scan cycle, and the second representative scan vector is generated during a second representative scan period corresponding the representative scan cycle, and
wherein the first representative scan period and the second representative scan period are discontinuous.

20. The pulse radar device of claim 19, wherein the pulse radar device configured to:
operate in the first mode during the first representative scan period and the second representative scan period; and
operate in the second mode during a third representative scan period between the first representative scan period and the second representative scan period.
